(19) United States
(12) Patent Application Publication
(10) Pub. No.: US 2009/0167670 A1
(43) Pub. Date: Jul. 2, 2009

(54) METHOD OF DETERMINING LUMINANCE VALUES FOR A BACKLIGHT OF AN LCD PANEL DISPLAYING AN IMAGE

(75) Inventors: Huajun Peng, Tai Po (HK); Wei Zhang, Clear Water Bay (HK); Chen-Jung Tsai, Hsinchu (TW); Chun Kit Hung, San Po Kong (HK)

Correspondence Address: LEYDIG VOIT & MAYER, LTD, 700 THIRTEENTH ST. NW, SUITE 300, WASHINGTON, DC, 20005-3960, US

(73) Assignee: HONG KONG APPLIED SCIENCE AND TECHNOLOGY RESEARCH INSTITUTE COMPANY LIMITED, Shatin (HK)

(21) Appl. No.: 11/964,156

(22) Filed: Dec. 26, 2007

(51) Int. Cl. G09G 3/36

(52) U.S. Cl. 345/102

(57) ABSTRACT

A controller for a backlight for a liquid crystal display (LCD) panel has at least two methods for determining illumination value for the backlight. The controller selects between the two methods based on properties of the image being displayed. The properties of the image include its color and its intensity.

### BACKGROUND TO THE INVENTION

1. Field of the Invention

The current invention relates to a method of determining luminance values for a backlight of an LCD panel displaying an image. The invention also related to a backlight device, for providing a backlighting to a LCD panel displaying a video image that is programmed to determining luminance values for the backlight in accordance with the method.

2. Background Information

A liquid crystal display (LCD) panel is not a spontaneous light emitting device. A voltage applied to the LCD panel changes the light transmittance of liquid crystal elements (pixels) in the panel. The LCD panel can be light reflective so that an image produced on the panel is seen by ambient light reflection. However, this does not work for large size or high contrast LCD panels.

For use in applications such as televisions, computer monitors and head-held electronic devices LCD panels are illuminated from behind by a backlight. In most applications the backlight has an even and constant light output with changes in the brightness of the displayed image being controlled by changing the light transmittance of the liquid crystal elements within the display panel. In order to produce good viewability in high ambient light conditions the backlight must have a high brightness, or intensity, level. There are a number of disadvantages in this including high power consumption, excess heat generation. Another disadvantage of a constant backlight is that it leads to limited dynamic contrast of an LCD display because of light leakage through the LCD panel from the backlight when the pixels are in a dark or off state. This light leakage causes the dark areas to have a gray appearance instead of a solid black appearance.

One technique intended to improve the dynamic range of an LCD display is to dynamically adjust the overall backlight brightness in accordance with brightness of the video image. If the image is relatively high intensity, the backlight control operates the light source at high intensity. If the image is darker, the backlight output is dimmed to reduce leakage and help darken the image. One benefit to this backlight technique is to reduce the backlight power consumption. Although this technique can improve the LCD contrast range and slightly save the backlight power, it can create image distortion and induce image brightness fluctuations.

### SUMMARY OF THE INVENTION

Accordingly, is an object of the present invention to provide a backlight device for providing backlighting to a liquid crystal display panel and a method of controlling brightness of a liquid crystal display panel which overcomes or substantially ameliorates the above problems.

There is disclosed herein a control method for a backlight of a LCD panel that has at least two methods for determining an illumination value for the backlight. The controller selects between the two methods based on properties of the image being displayed. Preferably, the properties of the image include its color and its intensity. If color is below a first threshold or intensity is above a second threshold then a first one of the means is selected, otherwise a second one of the means is selected. If the first means is selected then the illumination value is based on a peak intensity value of the image. If the second means is selected then the illumination value is based on an average intensity value of the image.

The invention is preferably practiced in a backlight having a plurality of independently controllable illumination regions. The image is notionally divided into a plurality of image blocks each corresponding to one of the backlight illumination regions. A method of determining an illumination value for each region of the backlight comprising determining whether a number n of pixels in the regions corresponding image block met certain criteria, and if n or more pixels meet the criteria then using a first method to determine an illumination value for the backlight, otherwise using a second method to determine the luminance value for the backlight. Preferably, criteria are color and intensity. A color saturation value and an intensity value are determined for at least n pixels in the image block, and wherein if the color saturation value of the n pixels is below the first threshold or the intensity value of the n pixels is above the second threshold then the first method to determine an illumination value is used, otherwise the second method to determine the luminance value is used.

In a preferred embodiment of the invention the first method to determine an illumination value is based on luma values of pixels in the image block and the second method to determine an illumination value is based on red, green and blue color component values of pixels in the image block.

Further aspects of the invention will become apparent from the following description which is given by way of example only.

### BRIEF DESCRIPTION OF THE DRAWINGS

An exemplary form of the present invention will now be described by way of example only and with reference to the accompanying drawings, in which:

FIG. 1 is a schematic overview of an LCD TV employing the method and apparatus of the invention,

FIG. 2 is an illustration of an image to be viewed on the LCD TV,

FIGS. 3 and 4 illustrate two sub-images or image blocks A, B from the image of FIG. 2,

FIGS. 5-10 are representative images illustrating a first method of determining backlight color and intensity for the LCD TV,

FIGS. 11-16 are representative images illustrating a second method of determining backlight color and intensity for the LCD TV, and

FIG. 17 is a flow diagram of an adaptive method of determining backlight color and intensity according to the invention.

### DESCRIPTION OF THE EXEMPLARY EMBODIMENTS

Reference will now be made in detail to an exemplary embodiment of the present invention, an example of which is illustrated in the accompanying drawings, wherein like reference numerals refer to like elements throughout.

The described exemplary embodiment illustrates the invention as practiced in a backlit LCD display, for example an LCD TV, used to show video images comprising a plurality of sequential frames each made up of a plurality of pixels. This is not intended to limit the scope of use or functionality of the invention. The invention is equally applicable to the enhancement of static images displayed on an LCD screen. For example, many organizations, advertisers or artisans use LCD screens to display static, albeit periodically changing, information, advertisements and/or photographs and images of artwork. The invention can equally be used to enhance the appearance on the screen of such information, advertisements and/or images.

Likewise, that the invention is exemplified as practiced in a backlit LCD display is not intended to limit the scope of use or functionality of the invention. The invention can equally be practiced in any display apparatus that uses a light source to project an image onto a projection surface or a flat panel display that uses a backlight to display images for direct viewing. Such displays include digital micro-mirror device displays (DMDs), liquid crystal on silicon (LCoS) displays and, of course, LCD displays.

In its earlier U.S. patent application Ser. No. 11/707,517, the entire contents of which are incorporated herein by reference, applicant describes an LCD display device having a backlight divided into a plurality of individually controllable illumination regions. Luminance of each illumination region is controlled in accordance with video signal properties for a corresponding region of the LCD display. If an area of the displayed image is bright, or has a high intensity, then the corresponding illumination region of the backlight has high luminance and if a region of the image is dark then the corresponding illumination region of the backlight has no or low luminance. By dynamically controlling luminance of each illumination region of the backlight in accordance with properties of a corresponding part of the displayed image the contrast and dynamic range of the displayed image is improved. Additionally, each individually controllable illumination region of the backlight may comprise a variable color lighting source, such as clusters of individually controllable red, green and blue (RGB) LEDs thus allowing the illumination region color to be controlled from black through the color spectrum to white. The backlight luminance and color can be dynamically controlled in accordance with properties of the corresponding part of the displayed image in order to improve both contrast and color dynamic range.

In U.S. patent application Ser. No. 11/707,517 the LEDs of the backlight are individually controlled and thus the brightness of the backlight is not uniform and varies with the image. Another benefit of this system is that the whole backlight brightness is generally dimmer than that of prior art constant backlight systems. This is because in lightly colored or high intensity areas of the display image the backlight will be at its maximum value, which might typically be the same brightness as a prior art constant backlight systems, however significant portions of the image will have lower brightness and thus the backlight will be dimmer. The result is that a backlight that has a plurality of individually controllable illumination regions has on average lower power consumption than prior art constant backlights or one where the whole backlight is dimmed uniformly, but dynamically based on displayed image brightness properties.

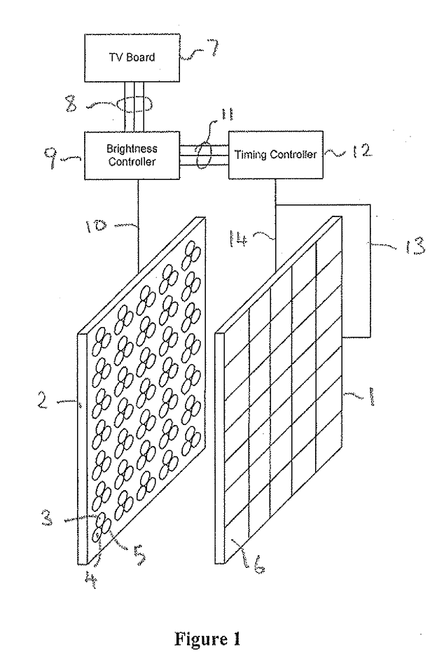

Referring to FIG. 1 there is shown a schematic overview of a backlit LCD display, in this instance a LCD TV, of the type described in U.S. patent application Ser. No. 11/707,517. The display comprises an LCD panel 1 located in front of a backlight 2. The backlight 2 is divided into a plurality of individually controllable illumination regions. In the illustrated embodiment there are only 5×7 regions shown for clarity. In the preferred embodiment of the invention each region comprises a cluster of red 3, green 4 and blue 5 LEDs so that the region light output can be from black to white through the color spectrum. This is not essential to the invention and in other embodiments the backlight regions comprises just white LEDs or other light sources. The LCD panel is notionally, but not physically, divided into multiple display regions 6. The TV board 7 receives image signals from various video sources such as PC, DVD player, Cable TV and so on, through analog or digital interfaces as is known. After processing the incoming signals, the TV board generates video signals 8 in RGB format and passes the video signal 8 to a brightness controller 9. The brightness controller 9 analyses the incoming video signal 8 and provides driving signals 10 to LED drivers of the individual illumination regions of the backlight 2. The driving signals 10 for the LED contain color and luminance information for each illumination regions of the backlight 2. In order to optimize backlight dimming, and thus power saving, while maintaining or maximizing image contrast and quality the driving signals 10 for the LEDs are determined using one of two methods for analyzing the LCD image signal 8. The method chosen for analyzing the LCD image signal 8 is determined adaptively depending on properties of the pixels within a respective image block to occupy a display region.

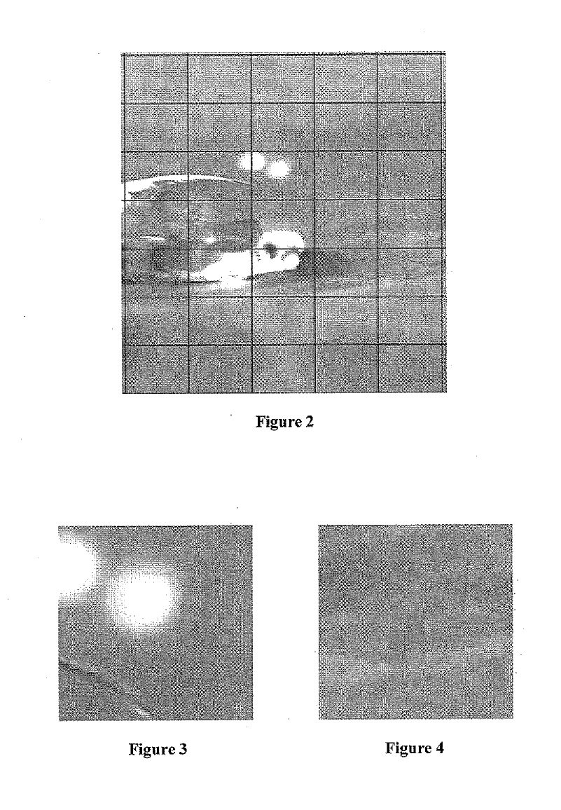

FIG. 2 illustrates an image to be shown on the LCD panel 1. The image, and all images, are shown in grayscale for reproduction purposes, but are in reality color images in RGB format. One can see that the image is predominantly of uniform color although the centre left portion of the image are characterized by areas of different colors having a high contrast with the predominant color of the image. A grid is shown superimposed over the image of FIG. 2 with each block in the grid representing a notional block of the corresponding LCD panel 1 and to one individually controllable illumination region of the backlight 2. The region of backlight behind each image block is individually controllable in terms of color and light intensity (luminance) based on the image properties of the block. FIGS. 3 and 4 are enlarged views of image blocks A and B respectively. One can see that in block B the image color is substantially uniform across the entire block, whereas in block A the image color is substantially uniform except for two white or lightly colored points in the top left-hand corner. These blocks A and B pose different problems in selecting an appropriate backlight color and intensity. In the current invention different criteria are used to analyze such different blocks in order to obtain the best final picture quality. The reason for and method of determining appropriate criteria are described in the following text.

As is well known to those skilled in the art an ROB image signal has three channels, namely red, green and blue, that can be thought of as three overlapping grayscale images that each store brightness intensity values for respective red, green and blue color component of each pixel in the image. The intensity values are represented by a n-bit integer. For a conventional 8-bit image this integer is in the range 0 through 255. A value of zero (0) means that the respective color component of the pixel is ‘off’. A value of 255 means that the respective color component of the pixel is ‘on’ with maximum intensity. A first method of determining LED color and intensity for the backlight is to find the average intensity value of the pixels in each of the three color channels. The image block is separated into its red, green and blue color channels and the intensity values of all pixels in each channel is summed and then divided by the number of pixels in the channel image block to find the average intensity value. This reveals that average intensity of each of the three color components, red, green and blue, in the image block. Each illumination region of the backlight is illuminated by clusters of red, green and blue LEDs so that the backlight region can provide colored backlight to the corresponding image block of the displayed image. The three average intensity values are used to determine the values of driving signals for respective red, green and blue LEDs in the corresponding illumination region of the backlight device. The desired backlight color and intensity are inherent in the three average values. Because the range of driving signal for each LED may not correspond to the driving signal range the average values may additionally be normalized.

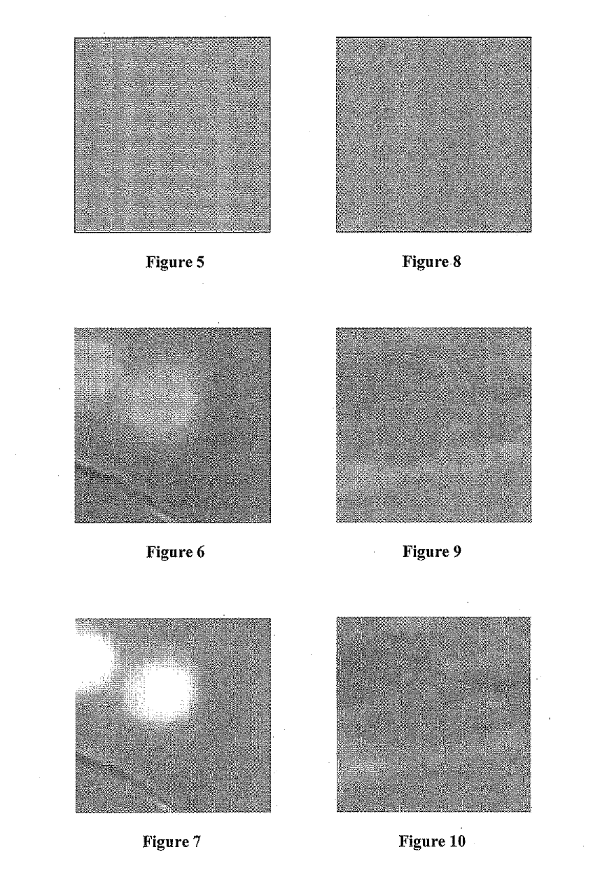

FIGS. 5 and 8 are grayscale illustrative blocks showing a representation of the backlight color and intensity when determined according to the above method. The respective color channel average intensity values for block A of FIG. 2 and block B of FIG. 3 are R=155, G=217, B=158 and R=151, G=216, B=123, We can estimate backlight power as a percentage by finding the average of the three channel values as percentage of maximum intensity 255. For FIG. 5 it is ((155+217+158)/3)/255 or approximately 70 percent (70%). For FIG. 8 it is approximately 64 percent (64%). The higher power of the FIG. 5 block is caused by the two lightly colored points in the top left-hand corner of the image. FIGS. 6, 7 and 9, 10 are grayscale representations to illustrate the effect of determining backlight color and intensity via the ROB average method. FIGS. 6 and 9 are illustrative views of how the original image block will look on the LCD display when backlit by the color and intensity shown in FIGS. 5 and 8 respectively. FIGS. 7 and 10 are the original images set forth for comparison. One can readily see in FIG. 6 that the intensity and contrast of the two lightly colored points in the top left corner is diminished by the effect of the backlight. A power saving has been achieved in reducing backlight intensity to 70%, but this has occurred at the expense of image quality and contrast. By comparison with FIG. 9 one can see that the image is unchanged and even enhanced with backlight dimming thus power saving has been achieved without reduction, and possibly with improvement, in image quality. The RGB averaging method of determining backlight color and intensity is suitable for a portion of image similar to that of block B but is not suitable to a portion of image of the type of block A which has high contrasting colors.

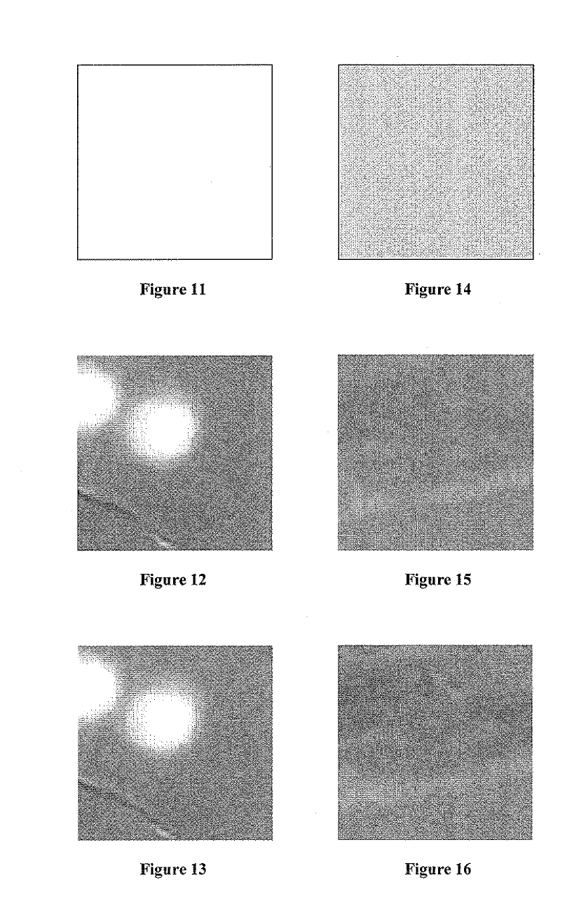

A second method of determining LED intensity for the backlight uses a Y-peak method. In the YUV color model color information of an image is separated from luma information. Luma represents the brightness of an image, i.e. the black or whiteness of the image. The data for each pixel is represented by three integers. The first or Y integer is the luma or brightness component and the second and third, or U and V, integers are the chrominance or color components. In the Y-peak method the RGB image block is converted to YUV color space and the LED driving signal is based on the peak Y value of all pixels in the block. The same driving signal is used for all red, green and blue LEDs so the corresponding backlight illumination region has no color and its intensity is controlled in white light only. FIGS. 11 and 14 are grayscale illustrative blocks showing a representation of the backlight intensity for image blocks A and B respectively when determined according to the Y peak method. For FIG. 11 the lightly color points have maximum intensity an so the backlight has maximum intensity of approximately 100 percent (100%) power. For FIG. 6 power is approximately 84 percent (84%). FIGS. 12, 13 and 15, 16 are grayscale representations to illustrate to effect of determining backlight intensity via the Y-peak method. FIGS. 12 and 15 are illustrative views of how the original image blocks will look on the LCD display when backlit by the backlight intensity shown in FIGS. 11 and 14 respectively. FIGS. 13 and 16 are the original image blocks set forth for comparison. One can readily see in FIGS. 12, 13 and 15, 16 that the image is unchanged and even enhanced with backlight intensity calculated by this method. However, the intensity and thus power of the backlight is higher than by the RGB average method, and thus image contrast and quality has been maintained and the expense of power saving.

Thus, in the current invention an adaptive dimming solution is implemented wherein either the RGB average method or the Y peak method is chosen to determined backlight color and/or intensity for individual illumination regions of the backlight depending upon properties of the notional image block that is being illuminated by that region. In the adaptive solution, if the number of lightly colored or high intensity pixels in an image block exceeds a predetermined threshold T3 then the Y-peak method of determining backlight intensity is used for that image block, otherwise the ROB average method is used.

A lightly color pixel is one that is white or has little color and so is nearly white. A pixel is classified as lightly colored if its color saturation, or colorfulness, is below a threshold T1. Each pixel is represented by three n-bit integers for the intensity of its red, green and blue components. In the invention the color saturation of a pixel is determined by dividing the difference between the maximum and minimum intensity values by the sum of the three intensity values as follows:

$$s = \frac{min ( R G B ) - min ( rGB )}{R + G + B}$$

The minimum color saturation is for a white pixels in which all three red, green and blue intensity values are equal and so the numerator in the about equation is zero. Thus s is zero (0) for a white pixel. The maximum color saturation is for a pixel that consists of one of just the primary colors, for example RGB values are 255:0:0, and thus s is one (1). In the preferred embodiment of the invention threshold T1 is 0.1, thus if s is below 0.1 then the pixel is considered to be lightly colored. The color saturation method of determining whether a pixel is lightly colored is not meant to limit the scope of use or functionality of the invention. A skilled addressee will appreciate that this is only one method of determining color of a pixel and whether a pixel is lightly colored, and other equally valid methods are readily available. For example one may convert the pixel to the YUV color space and determine color from the U and V components.

A pixel is classified as having high intensity if a determined intensity value for the pixel is above a second threshold T2. In the preferred embodiment of the invention the intensity value of a pixel is the mean of the two highest intensity values of the pixel. So, in a pixel having RGB intensity values of, say, R==150, G=250, B=180 the intensity value is 215 (i.e. (250+180)/2). In the present context high is a relative term and whether a pixel has high intensity is depends on the intensity of other pixels in the image or image block. To account for this in the preferred embodiment of the invention the second threshold T2 is a dynamic value equal to the mean intensity of all pixels in the image or image block of the pixel being evaluated. If the mean of the two highest RGB intensity values in a pixel is above the mean intensity of all pixels in the block then the pixel is considered to have a high intensity. This method of determining whether a pixel has high intensity is not meant to limit the scope of use or functionality of the invention. A skilled addressee will appreciate that this is only one methods of determining whether a pixel has high intensity and other methods are available. For example, a simple method is to compare the average intensity of the three RGB intensity values to a predetermined value of, say, 200 for an intensity range of 0-255.

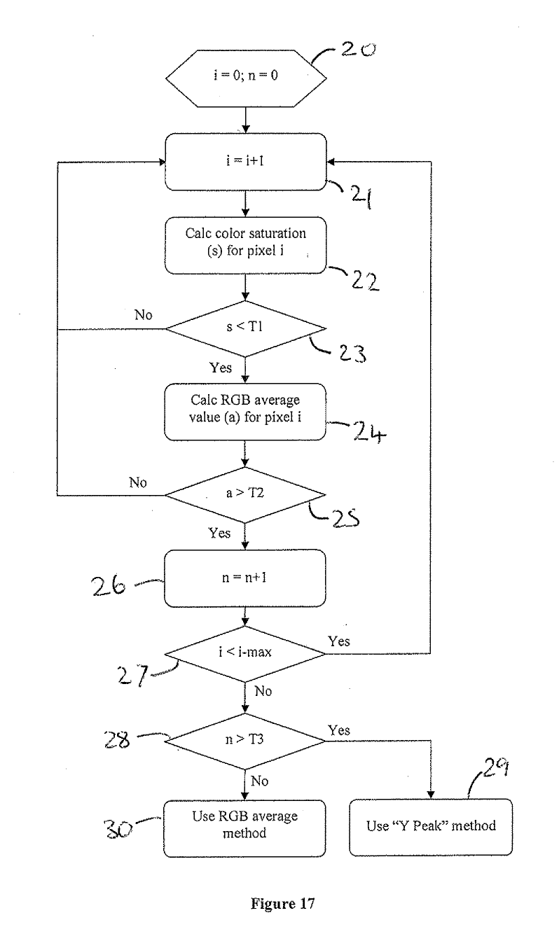

FIG. 17 is a flow diagram of this adaptive dimming solution for determining which scheme should be used for determining the appropriate backlight properties of an illumination region backlight from the corresponding image block properties. Firstly, when the decision module is called in preparation block 20 two variables i and n are set to zero. Variable i representing the image pixel currently being assessed and variable n is a counter used to keep track of the number of lightly colored and high intensity pixels in the image block. Moving to process block 21 the pixel counter i is incremented by one so that the current analysis is performed on pixel number 1 in the current image block. Moving on to process block 22 the next step in the method is to calculate the color saturation, represented by numeral s, for the present pixel i. In decision block 23 the color saturation s is compared with the first threshold value T1. If the color saturation is below threshold T1, classifying a lightly colored pixel, the method moves on to the next step in process block 24, otherwise a method returns to process block 21 incrementing the pixel counter by one and repeating process 22 for the next pixel in the block.

In process block 24 the method calculates the RGB average value, represented by numeral a, for the current pixel i. The RGB average value is determined by separating the pixel signal into its individual red, green and blue color channels, determining the color value of each channel, summing the individual values and dividing the sum by 3 (the number of color channels). In decision block 24 the RGB average value a is compared with a second threshold T2. If value a is above threshold T2, classifying a high intensity pixel, then the method moves on the step of process block 26, otherwise it returns to process block 21 incrementing the value of the pixel counter i by one and repeating steps.

In process block 26 the method increments the counter n which is tracking the number of lightly colored and high intensity pixels in the image block, i.e. pixels with a color saturation s below T1 and an RGB average value a above T2. The method moves to decision block 27 which compares the pixel counter i to the maximum number of pixels i-max in an image block. If pixel counter i has not yet reached the maximum value, meaning that not all pixels in the block have been analyzed, the method returns to process block 21 which increments the pixel counter i and continues.

If pixel counter i has reached the maximum pixel value then no more pixels are left to analysis and so the process moves to decision block 28 which compares counter n with a third threshold value T3. If n is greater than threshold T3, indicating that the number of lightly colored and high intensity pixels in the image block has exceeded the threshold, the method moves to process block 29 which invokes the Y-peak method for determining backlight color and intensity. If counter n is below threshold T3 the method moves to process block 30 which invokes the use of the RGB average method for determining backlight color and intensity

Thus, according to the invention an adaptive solution is used in order to determine the method by which backlight color and intensity is determined from individual pixel properties within an image block, so that the best color and intensity for each individual backlight region of the backlight can be chosen. This results in the optimum solution for both image quality and power saving.

1. A method of controlling a backlight for a liquid crystal display (LCD) panel displaying a video image comprising a plurality of image frames, the controller having at least two methods for determining an illumination value for the backlight, wherein the method comprises selecting between the at least first and second methods based on properties of an image frame.

2. The method of claim 1 wherein selecting between the at least first and second methods is based on properties of an image frame and repeating the lectin for each image frame in the video image.

3. The method of claim 1, wherein the properties of the image frame include color and intensity.

4. The method of claim 3, wherein, if the color is below a first threshold or the intensity if above a second threshold, selecting the first method, otherwise selecting the method.

5. The method of claim 1, wherein, if the first method is selected, determining an illumination value based on a peak intensity value of the image frame, and, if the second method is selected, determining an illumination value based on an average intensity value of the image frame.

6. A method of determining illumination values for a backlight of a liquid crystal display (LCD) panel displaying an image, the backlight comprising a plurality of independently controllable illumination regions and the image being notionally divided into a plurality of image blocks, each image block corresponding to one of the backlight illumination regions, the image blocks comprising a plurality of image pixels having pixel color and brightness properties, the method comprising determining whether a number n of pixels in an image block meet a criterion, and, if n or more pixels meet the criterion using a first method to determine an illumination value for the backlight corresponding the image block, otherwise using a second method to determine the luminance value for the backlight corresponding to the image block.

7. The method of claim 6, wherein
the method comprises determining a color value and/or an intensity value for at least n pixels in the image block, and,
if the color value of the n pixels is below a first threshold or the intensity value of the n pixels is above a second threshold, using the first method to determine an illumination value, and otherwise using the second method to determine illumination value.

8. The method of claim 7 including choosing the first threshold to determine whether a pixel is lightly colored.

9. The method of claim 7 including choosing the second threshold to determine whether a pixel has a high intensity.

10. The method of claim 7, wherein each pixel has red, green, and blue intensity values and including choosing the second threshold to determine whether an average of any two of the red, green, and blue intensity values exceeds a second threshold value.

11. The method of claim 9, wherein the second threshold is an average intensity of all pixels in the image block.

12. The method of claim 7, wherein the first threshold is 10% of a maximum color value.

13. The method of claim 7, wherein the first threshold is set between 5% to 30% of a maximum color value.

14. The method of claim 1, wherein the first method is based on luma values of pixels in the image frame.

15. The method of claim 1, wherein the second method is based on red, green, and blue color component values of pixels in the image frame.

16. A backlight device, for providing backlighting to a liquid crystal display (LCD) panel displaying a video image, the backlight device being programmed to determine illumination values for the backlight in accordance with the method of claim 1.

17. The method of claim 6, wherein the first method is based on luma values of pixels in the image block.

18. The method of claim 6, wherein the second method is based on red, green, and blue color component values of pixels in the image block.

19. A backlight device for providing backlighting to a liquid crystal display (LCD) panel displaying a video image, the backlight device being programmed to determine illumination values for the backlight in accordance with the method of claim 6.
